(19) United States
(12) Patent Application Publication
(10) Pub. No.: US 2009/0142155 A1
(43) Pub. Date: Jun. 4, 2009

(54) ANTI-LOOSENING UNIT

(75) Inventor: Yong-Tseh SU, Shanhua Township (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: TU-GLOBAL CO., LTD., Shanhua Township (TW)

(21) Appl. No.: 11/949,074

(22) Filed: Dec. 3, 2007

(51) Int. Cl. F16B 33/04

(52) U.S. Cl. 411/7

(57) ABSTRACT

The present invention relates to an anti-loosening unit comprising at least one ringed plate. The ringed plate has slots, cuneal structures and protrusions. The cuneal structures match other corresponding cuneal structures of other corresponding elements. The slots serve to reduce the contact area of corresponding cuneal structures. With a small dragging force between the ringed plate and the other corresponding elements, the ringed plate slides easily to cause an axial displacement, thereby producing an axial stress. The axial stress will increase the friction between the protrusions and the element surface, so the anti-loosening unit is not easily rotated, and the anti-loosening effect is achieved. Furthermore, the slots of the ringed plate can reduce the deformation of the ringed plate, and the production quality is improved.

### BACKGROUND OF THE INVENTION

1. Field of the Invention

The present invention relates to an anti-loosening unit, particularly to an anti-loosening unit having cuneal structures and protrusions.

2. Description of the Related Art

FIG. 1 is a schematic view of a conventional anti-loosening element (a washer). The conventional anti-loosening element 1 has an opening 11, a plurality of cuneal structures 12 and a plurality of waved structures 13. The opening 11 is formed in the central portion. The cuneal structures 12 and the waved structures 13 are formed on both sides of the anti-loosening element 1. The cuneal structures 12 and the waved structures 13 are formed continuously around the opening 11 and extend from the opening 11 to the outer edge of the anti-loosening element 1, wherein the adjacent cuneal structures 12 form a height difference.

FIG. 2 is an exploded perspective view showing two conventional anti-loosening elements combined with a bolt and a nut for fixing a workpiece. FIG. 3 is an assembly drawing of the conventional anti-loosening elements combined with the bolt and the nut for fixing the workpiece. In the embodiment of FIG. 2 and FIG. 3, the cuneal structures 12 of a first conventional anti-loosening element 1 match with the cuneal structures 141 of the bolt 14, and the waved structures 13 of the first conventional anti-loosening element 1 contact one side of the workpiece 16. Also, the cuneal structures 12′ of a second conventional anti-loosening element 1′ match with the cuneal structures 151 of the nut 15, and the waved structures 13′ of the second conventional anti-loosening element 1′ contact the other side of the workpiece 16. The bolt 14 penetrates the first conventional anti-loosening element 1, the workpiece 16, the second conventional anti-loosening element 1′ and the nut 15, and the workpiece 16 is fixed between the waved structures 13 of the first conventional anti-loosening element 1 and the waved structures 13′ of the second conventional anti-loosening element 1′.

Thus, the friction between the cuneal structures 12 and the cuneal structures 141 or the cuneal structures 12′ and the cuneal structures 151 is smaller than that between the waved structures 13 and the workpiece 16 and that between the waved structures 13′ and the workpiece 16, so the cuneal structures 12, the bolt 14 and the nut 15 can slide easily to cause an axial displacement, thereby producing an axial stress. The axial stress will increase the friction between the waved structures 13 and the workpiece 16 and the friction between the waved structures 13′ and the workpiece 16, resulting in an anti-loosening effect of the conventional anti-loosening elements 1 and 1′.

However, since the waved structures 13 and 13′ have waved surfaces, the friction between the waved structures 13 and the workpiece 16 and the friction between the waved structures 13′ and the workpiece 16 cannot completely prevent the waved structures 13, 13′ and the workpiece 16 from sliding and rotating. Therefore, the conventional anti-loosening element 1 and 1′ cannot strongly engage the workpiece 16; in other words, the first conventional anti-loosening element 1 and the second conventional anti-loosening element 1′ have a poor anti-loosening effect.

Consequently, there is an existing need for providing an anti-loosening unit to solve the above-mentioned problem.

### SUMMARY OF THE INVENTION

The present invention is directed to an anti-loosening unit which comprises at least one ringed plate, said ringed plate comprising an opening, a plurality of slots, a plurality of cuneal structures and a plurality of protrusions. The opening is formed in the central portion of the ringed plate. The slots are formed radially on a first surface of the ringed plate and around the opening, wherein the slots extend from the opening to the outer edge of the ringed plate. The cuneal structures are formed between the slots, and each cuneal structure has a contact surface. The contact surface is an inclined surface between two adjacent slots. The protrusions are formed on a second surface of the ringed plate, wherein the second surface corresponds to the first surface, and the protrusions are formed radially on the second surface.

In the present invention, the ringed plate can be combined with other corresponding elements, for example, cuneal structures of a bolt or cuneal structures of a nut. The friction between the cuneal structures and the cuneal structures of the other corresponding elements is smaller than that between the protrusions and an element surface, and the slots serve to reduce the contact area of corresponding cuneal structures. Therefore, there is a small dragging force between the ringed plate and the other corresponding elements, so the ringed plate can slide easily along the contact surfaces of the cuneal structures to cause an axial displacement, thereby producing an axial stress. The axial stress will increase the friction between the protrusions and the element surface, so the protrusions can further lodge into the element surface. Thus, the anti-loosening unit is not easily rotated and the anti-loosening effect is achieved. Furthermore, since the ringed plate has slots, deformation of the ringed plate can be reduced, and the production quality is improved.

### BRIEF DESCRIPTION OF THE DRAWINGS

FIG. 1 is a schematic view of an anti-loosening element;

FIG. 2 is an exploded perspective view showing two conventional anti-loosening elements combined with a bolt and a nut for fixing a workpiece;

FIG. 3 is an assembly drawing of the conventional anti-loosening elements combined with the bolt and the nut for fixing the workpiece;

FIG. 4 is a schematic view of an anti-loosening unit according to a first embodiment of the present invention;

FIG. 5 is a partial cross-sectional view of the anti-loosening unit according to the first embodiment of the present invention;

FIG. 6 is a schematic view of an anti-loosening unit according to a second embodiment of the present invention;

FIG. 7 is a schematic view of an anti-loosening unit according to a third embodiment of the present invention;

FIG. 8 is a schematic view of an anti-loosening unit according to a fourth embodiment of the present invention;

FIG. 9 is a schematic view of an anti-loosening unit according to a fifth embodiment of the present invention;

FIG. 10 is a schematic view of an anti-loosening unit according to a sixth embodiment of the present invention; and

FIG. 11 is a schematic view of an anti-loosening unit according to a seventh embodiment of the present invention.

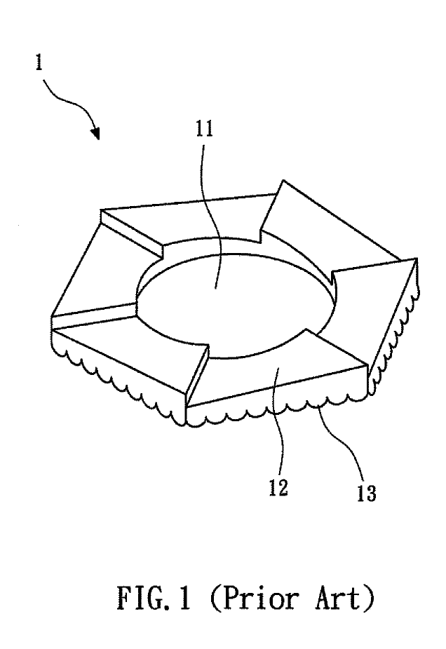

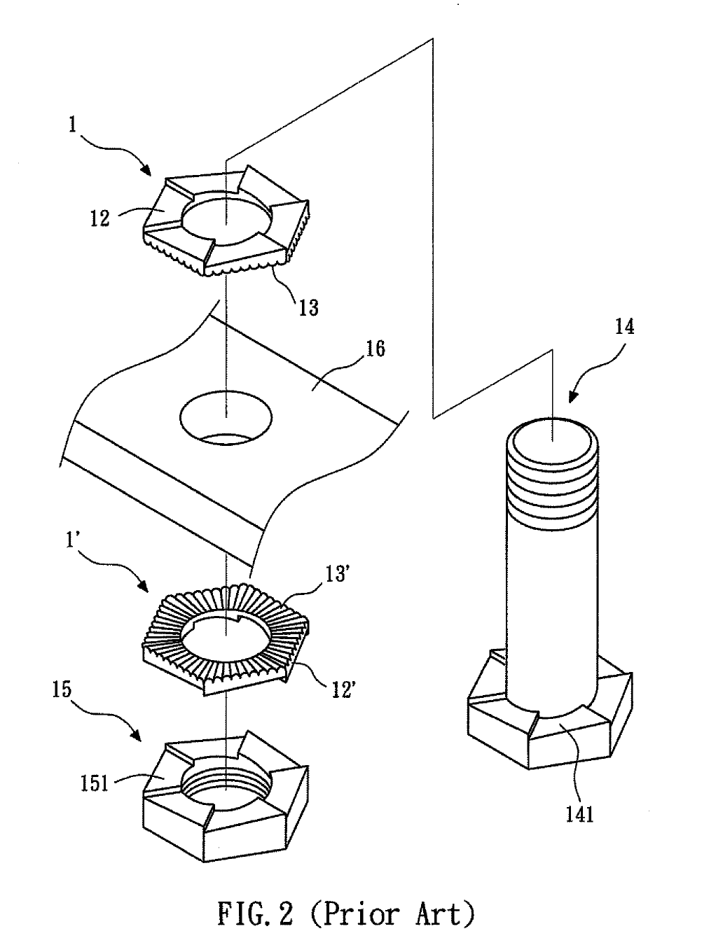

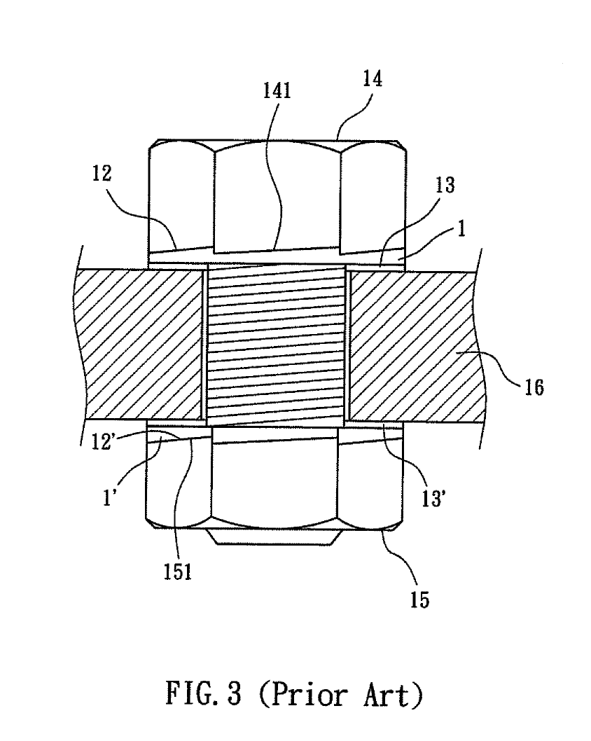

### DETAILED DESCRIPTION OF THE INVENTION

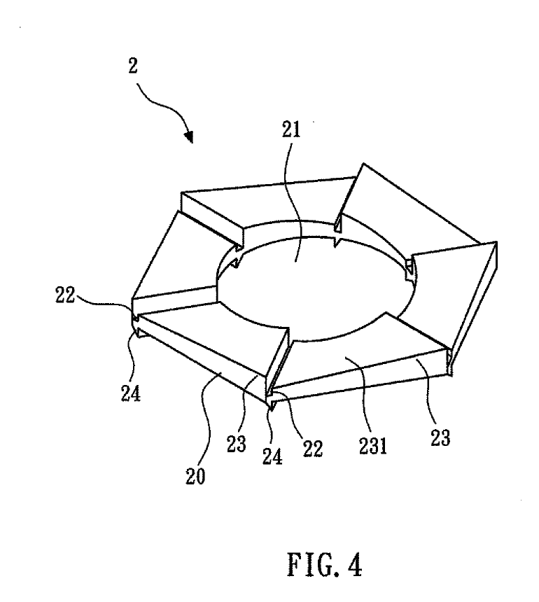

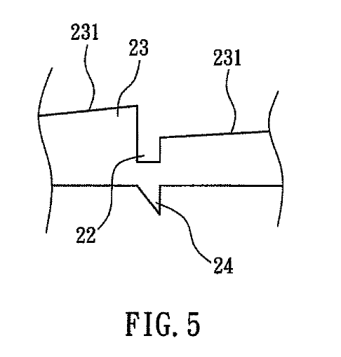

FIG. 4 is a schematic view of an anti-loosening unit according to a first embodiment of the present invention. FIG. 5 is a partial cross-sectional view of the anti-loosening unit according to the first embodiment of the present invention. In FIG. 4 and FIG. 5, the anti-loosening unit 2 of the first embodiment comprises a ringed plate 20. The ringed plate 20 comprises an opening 21, a plurality of slots 22, a plurality of cuneal structures 23 and a plurality of protrusions 24. The opening 21 is formed in the central portion of the ringed plate 20.

In this embodiment, the slots 22 are formed radially on a first surface of the ringed plate 20 and around the opening 21, wherein the slots 22 extend from the opening 21 to the outer edge of the ringed plate 20 and are spaced at an equal angle. It should be noted that, in this embodiment, the slots 22 are rectangular slots. In other applications, the slots 22 may be curve slots. Preferably, the ringed plate 20 comprises six to thirty-six slots. In this embodiment, the ringed plate 20 has six slots, but the number is not limited to six. In other applications, the ringed plate 20 may have eight, twelve, twenty-four or thirty-six slots. The cuneal structures 23 are formed between the slots 22. Each cuneal structure 23 has a contact surface 231, wherein the contact surface 231 is preferably an inclined surface between two adjacent slots 22.

The protrusions 24 are formed on a second surface of the ringed plate 20, wherein the second surface corresponds to the first surface. The protrusions 24 are formed radially on the second surface. In this embodiment, the protrusions 24 are formed around the opening 21, and the protrusions 24 are preferably ridge structures. Also, the protrusions 24 and the cuneal structures 23 are of equal number, and the protrusions 24 correspond to the cuneal structures 23. In other applications, there may be more protrusions 24 than cuneal structures 23.

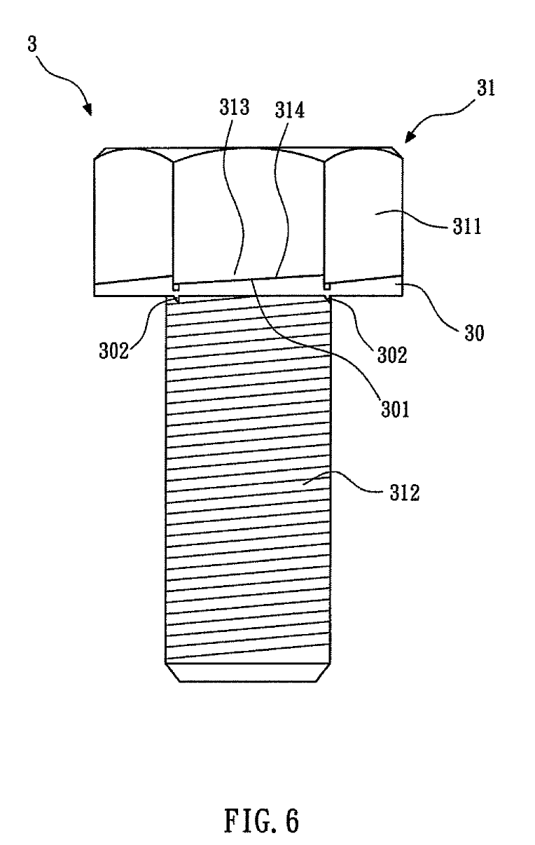

FIG. 6 shows a schematic view of an anti-loosening unit according to a second embodiment of the present invention. The anti-loosening unit 3 of the second embodiment comprises a ringed plate 30 and a bolt 31. The ringed plate 30 is the same as the ringed plate 20 in the first embodiment. Thus, the ringed plate 30 is not described in detail herein.

The bolt 31 has a head portion 311 and a rod portion 312, wherein the head portion 311 has a plurality of cuneal structures 313, and each cuneal structure 313 of the head portion 311 has a contact surface 314. The contact surfaces 314 of cuneal structures 313 of the head portion 311 match the cuneal structures 301 of the ringed plate 30, and the rod portion 312 penetrates the opening of the ringed plate 30.

The anti-loosening unit 3 of the second embodiment can be combined with a workpiece (not shown), wherein the protrusions 302 of the ringed plate 30 contact the workpiece. Thus, the friction between the cuneal structure 313 of the head portion 311 and the cuneal structures 301 of the ringed plate 30 is smaller than that between the protrusions 302 of the ringed plate 30 and the workpiece, so the ringed plate 30 and the bolt 31 can slide easily to cause an axial displacement to produce an axial stress. The axial stress will increase the friction between the protrusions 302 of the ringed plate 30 and the workpiece. Thus, the anti-loosening unit 3 is not easily rotated and the anti-loosening effect is achieved.

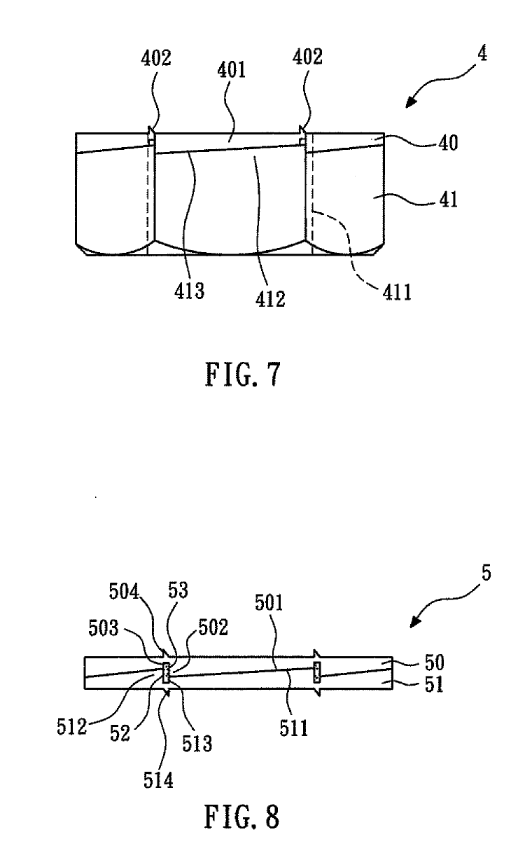

FIG. 7 shows a schematic view of an anti-loosening unit according to a third embodiment of the present invention. The anti-loosening unit 4 of the third embodiment comprises a ringed plate 40 and a nut 41. The ringed plate 40 is the same as the ringed plate 20 in the first embodiment. Thus, the ringed plate 40 is not described in detail herein.

In this embodiment, the nut 41 has an opening 411 and a plurality of cuneal structures 412 formed around the opening 411 of the nut 41, each cuneal structure 412 of the nut 41 has a contact surface 413, and the contact surfaces 413 of cuneal structures 412 of the nut 41 contact the cuneal structures 401 of the ringed plate 40.

The anti-loosening unit 4 of the third embodiment can be combined with a workpiece (not shown), wherein the protrusions 402 of the ringed plate 40 contact the workpiece. Thus, the friction between the cuneal structure 412 of the nut 41 and the cuneal structures 401 of the ringed plate 40 is smaller than that between the protrusions 402 of the ringed plate 40 and the workpiece, so the ringed plate 40 and the nut 41 can slide easily to cause an axial displacement to produce an axial stress. The axial stress will increase the friction between the protrusions 402 of the ringed plate 40 and the workpiece increase. Thus, the anti-loosening unit 4 is not easily rotated and the anti-loosening effect is achieved.

FIG. 8 shows a schematic view of an anti-loosening unit according to a fourth embodiment of the present invention. The anti-loosening unit 5 of the fourth embodiment comprises at least two ringed plates 50, 51. The ringed plates 50, 51 are the same as the ringed plate 20 in the first embodiment. Thus, the ringed plates 50, 51 are not described in detail herein. In this embodiment, the contact surfaces 501, 511 of the two ringed plates 50, 51 contact each other, and the corresponding cuneal structures 502, 512 of the ringed plates 50, 51 and the corresponding slots 503, 513 form a plurality of apertures 52.

It should be noted that an adhesive material 53 is preferably disposed between the apertures 52 so as to slightly connect the ringed plates 50, 51. Thus, the anti-loosening unit 5 with the two ringed plates 50, 51 can be easily applied to an element which matches the anti-loosening unit 5. Also, the ringed plates 50, 51 have a small combination force therebetween, so the corresponding contact surfaces 501, 511 of cuneal structures 502, 512 of the ringed plates 50, 51 can slide easily to cause an axial displacement to produce an axial stress when the anti-loosening unit 5 is combined with other corresponding elements and the protrusions 504 of the ringed plate 50 or the protrusions 514 of the ringed plate 51 contact the other corresponding elements.

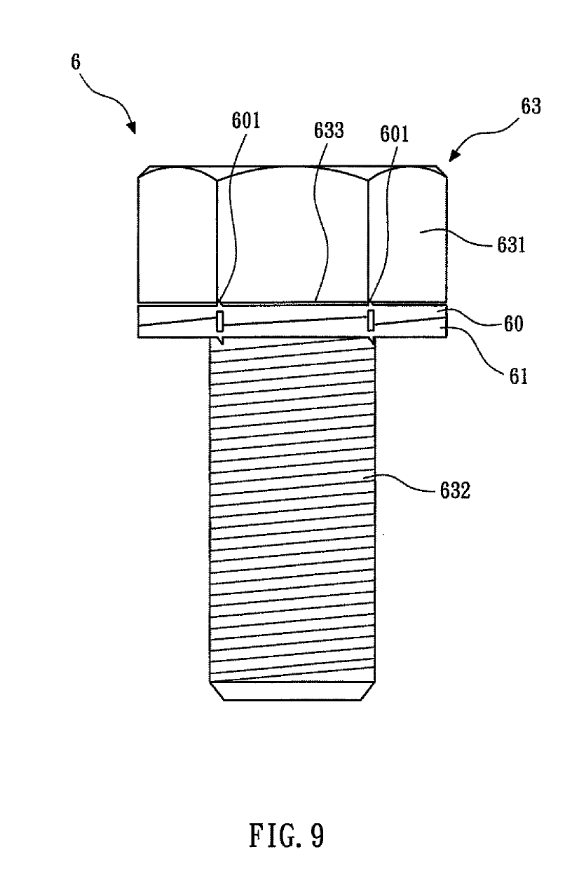

FIG. 9 shows a schematic view of an anti-loosening unit according to a fifth embodiment of the present invention. The anti-loosening unit 6 of the fifth embodiment comprises two ringed plates 60, 61 and a bolt 63. The ringed plates 60, 61 are the same as the ringed plates 50, 51 in the fourth embodiment. Thus, the ringed plates 60, 61 are not described in detail herein. In this embodiment, the bolt 63 has a head portion 631 and a rod portion 632, wherein the head portion 631 has a flat surface 633, and the rod portion 632 penetrates the openings of the two ringed plates 60, 61. In this embodiment, the protrusions 601 of the ringed plate 60 contact the flat surface 633 of the head portion 632.

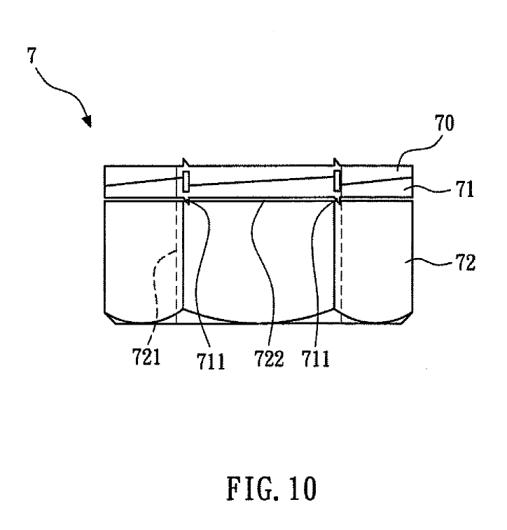

FIG. 10 shows a schematic view of an anti-loosening unit according to a sixth embodiment of the present invention. The anti-loosening unit 7 of the sixth embodiment comprises two ringed plates 70, 71 and a nut 72. The ringed plates are the same as the ringed plates 50, 51 in the fourth embodiment. Thus, the ringed plates 70, 71 are not described in detail herein. In this embodiment, the nut 72 has an opening 721 and a flat surface 722. In this embodiment, the protrusions 711 of the ringed plate 71 contact the flat surface 722 of the nut 72.

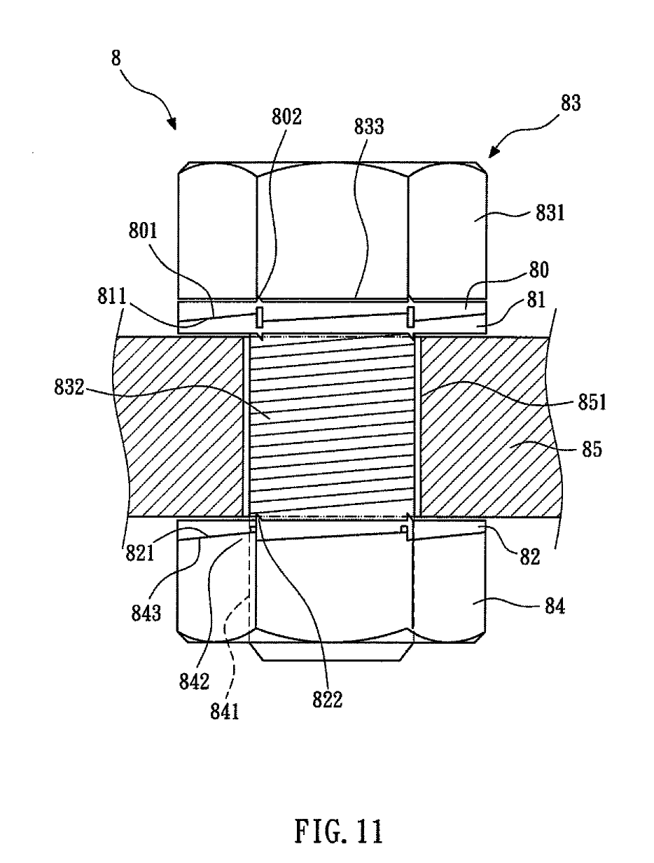

FIG. 11 shows a schematic view of an anti-loosening unit according to a seventh embodiment of the present invention. The anti-loosening unit 8 of the seventh embodiment comprises three ringed plates 80, 81, 82, a bolt 83 and a nut 84. The ringed plates 80, 81, 83 are the same as the ringed plate 20 in the first embodiment. Thus, the ringed plates 80, 81, 82 are not described in detail herein.

In this embodiment, the ringed plates 80, 81, 82 include a first ringed plate 80, a second ringed plate 81 and third ringed plate 82. The bolt 83 has a head portion 831 and a rod portion 832, wherein the head portion 831 has a flat surface 833, and the rod portion 832 penetrates the openings of the first ringed plate 80 and the second ringed plate 81. The contact surfaces 801 of the first ringed plate 80 and the contact surfaces 811 of the second ringed plate 81 contact each other and the protrusions 802 of the first ringed plate 80 contact the flat surface 833 of the head portion 831.

The nut 84 has an opening 841 and a plurality of cuneal structures 842 formed around the opening 841 of the nut 84, wherein each cuneal structure 842 of the nut 84 has a contact surface 843, the contact surfaces 843 of the nut 84 match the contact surfaces 821 of the third ringed plate 82. The rod portion 832 further penetrates an opening 851 of a workpiece 85, the third ringed plate 82 and the opening 841 of the nut 84, and the workpiece 85 is fixed between the second ringed plate 81 and the third ringed plate 82. The protrusions 811 of the second ringed plate 81 and the protrusions 822 of the third ringed plate 82 contact the workpiece 85.

In the above-mentioned embodiments of the present invention, the friction between the cuneal structures and the cuneal structures of the other corresponding elements, for example, cuneal structures of a bolt or cuneal structures of a nut, is smaller than that between the protrusions and an element surface, for example, a flat surface of a bolt, a flat surface of a nut or a workpiece surface, and the slots serve to reduce the contact area of corresponding cuneal structures. Therefore, there is a small dragging force between the ringed plate and the other corresponding elements, so that the ringed plate slides easily along the contact surfaces of the cuneal structures to cause an axial displacement, thereby producing an axial stress. The axial stress will increase the friction between the protrusions and the element surface, so the protrusions can further lodge into the element surface. Thus, the anti-loosening unit is not easily rotated and the anti-loosening effect is achieved. Furthermore, since the ringed plate has slots, deformation of the ringed plate can be reduced, and the production quality is improved.

While the embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications that maintain the spirit and scope of the present invention are within the scope as defined in the appended claims.

What is claimed is:

1. An anti-loosening unit, comprising:
at least one ringed plate, the ringed plate comprising:
an opening, formed in the central portion of the ringed plate;
a plurality of slots, formed radially on a first surface of the ringed plate and around the opening, wherein the slots extend from the opening to the outer edge of the ringed plate;
a plurality of cuneal structures, formed between the slots, each cuneal structure having a contact surface, wherein the contact surface is an inclined surface between two adjacent slots; and
a plurality of protrusions, formed on a second surface of the ringed plate, the second surface corresponding to the first surface, wherein the protrusions are formed radially on the second surface.

2. The anti-loosening unit according to claim 1, wherein the amount of the protrusions is equal to that of the cuneal structures.

3. The anti-loosening unit according to claim 2, wherein the protrusions correspond to the cuneal structures.

4. The anti-loosening unit according to claim 1, wherein the number of the protrusions is larger than that of the cuneal structures.

5. The anti-loosening unit according to claim 1, wherein the slots are spaced by an equal angle.

6. The anti-loosening unit according to claim 1, wherein the slots are rectangular slots.

7. The anti-loosening unit according to claim 1, wherein the slots are curve slots.

8. The anti-loosening unit according to claim 1, wherein the protrusion are ridge structures.

9. The anti-loosening unit according to claim 1, further comprising a bolt, the bolt having a head portion and a rod portion, the head portion having a plurality of cuneal structures, each cuneal structure of the head portion having a contact surface, the contact surfaces of cuneal structures of the head portion matching those of the ringed plate, and the rod portion penetrating the opening of the ringed plate.

10. The anti-loosening unit according to claim 1, further comprising a nut, the nut having an opening and a plurality of cuneal structures formed around the opening, each cuneal structure of the nut having a contact surface, and the contact surfaces of cuneal structures of the nut matching those of the ringed plate.

11. The anti-loosening unit according to claim 1, wherein the ringed plate comprises six to thirty-six slots.

12. The anti-loosening unit according to claim 1, further comprising a first ringed plate and a second ringed plate, wherein the contact surfaces of the first ringed plate and the contact surfaces of the second ringed plate contact each other.

13. The anti-loosening unit according to claim 12, wherein the corresponding cuneal structures and the corresponding slots of the first ringed plate and the second ringed plate form a plurality of apertures.

14. The anti-loosening unit according to claim 13, further comprising an adhesive material disposed between the apertures.

15. The anti-loosening unit according to claim 12, further comprising a bolt, the bolt having a head portion and a rod portion, the head portion having a flat surface, the rod portion penetrating the openings of the first ringed plate and the second ringed plate, and the protrusions of one of the first ringed plate and the second ringed plate contacting the flat surface.

16. The anti-loosening unit according to claim 15, further comprising a nut and a third ringed plate, the protrusions of the first ringed plate contacting the flat surface, the nut having an opening and a plurality of cuneal structures formed around the opening of the nut, each cuneal structure of the nut having a contact surface, the contact surfaces of the nut matching those of the third ringed plate, wherein the rod portion further penetrates an opening of a workpiece, the third ringed plate and the opening of the nut, the workpiece is fixed between the second ringed plate and the third ringed plate, and the protrusions of the second ringed plate and the third ringed plate contact the workpiece.

17. The anti-loosening unit according to claim 12, further comprising a nut, the nut having an opening and a flat surface, and the protrusions of one of the first ringed plate and the second ringed plate contacting the flat surface of the nut.
